(19) United States
(12) Patent Application Publication
(10) Pub. No.: US 2005/0086535 A1
(43) Pub. Date: Apr. 21, 2005

(54) Method for authenticating a user for the purposes of establishing a connection from a mobile terminal to a WLAN network

(75) Inventors: Roland Ernst, Unterbreizbach (DE); Petra Kastl, Melsungen Ot Adelshausen (DE); Manfred Leitgeb, Gramatneusiedl (AT); Hagen Scheibe, Ottobrunn (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/916,623

(22) Filed: Aug. 12, 2004

(30) Foreign Application Priority Data
Oct. 21, 2003 (DE) 10348912.6

(51) Int. Cl. H04L 9/32

(52) U.S. Cl. 713/201

(57) ABSTRACT

Method for authenticating a user for the purposes of establishing a connection from a mobile terminal to a WLAN network A user in a telecommunications network wishes do use a WLAN access. To do this he needs a WLAN authentication token, a login and a password. The key point of the invention is that, for the transmission and communication of the authentication data to the WLAN, it is not the SMS protocol which is used but the alternative USSD (Unstructured Supplementary Service Data) protocol. These so-called USSD strings can be easily entered by users on their terminal keypads. The USSD string is then not sent to the SMS gateway, as in the known method, but is sent directly to the Home Location Register (HLR) of the mobile radio network.

### FIELD OF THE INVENTION

The invention relates to a method of authentication, as is required for secure access by a WLAN-enabled terminal in a WLAN network in accordance with Patent claim 1.

WLAN (Wireless Local Area Network) has been developed along-side GSM, GPRS and UMTS as an additional mobile access option for a data network of a mobile service provider, such as the Internet or corporate data networks. The IEEE, the American Institute of Electrical and Electronic Engineers, has defined a number of standards for these wireless transmission networks. Standards IEEE 802.11a and b are the main standards that are relevant to WLAN.

In recent times public access via WLAN has also been offered. Users access the system via what is known as a hot spot which can belong to a specific mobile network operator. These hot spots are located in frequented areas such as hotels, airports or stations. This means that business travelers can retrieve their e-mail, surf the Internet or process data while they are away from the office.

Since these hot spots are accessible to the general public it is an important task to guarantee secure authentication of the user. The correct authentication ensures that only authorized users are also given access to specific data. Furthermore this user authorization is also used for billing.

### PRIOR ART

To use WLAN networks a user typically needs a user authorization. The user either obtains a WLAN “calling card (prepaid)” or pays using his credit card.

WLAN to 3GPP interworking follows known, partly standardized approaches. The SMS approach is not standardized for authentication and authorization but is known.

Thus T-Mobile Austria for example announced a new method for authentication on 19 Nov. 2002. What is known as a virtual recharge card, which is initially provided for 120 minutes of WLAN use, can be ordered quickly and easily at any 15 time using an SMS.

The ordering process functions as follows: The customer sends a free SMS to a specific service directory number to order a virtual recharge card. He is then sent an SMS in response in which he is informed about the costs of the virtual recharge card. As soon as the customer has sent an acknowledgement SMS he is sent this virtual card by means of a further SMS which gives him his user name, his password and the Internet address under which he can dial in. This virtual recharge card has a prezpecified lifetime. By entering his user name and password the user can then start using the network. Logging in uses a standardized security procedure.

This method using SMSs has various disadvantages:
SMS is what is known as a “store and forward” method. This means that the SMS message can only ever be forwarded to the next network node when the latter is once again ready to receive. This leads to significant time lags between transmitting and receiving an SMS. Furthermore the actual delivery of the SMS to the recipient is not guaranteed.
The SMS service is not available in all roaming scenarios (especially in the case of prepaid). This will only be guaranteed by the worldwide introduction of the CAMEL-3 Standard.
A further disadvantage is that the SMS Service Center must be set up for this specific application. Thus the user can only use the method if the network operator offers him this facility via their SMSC.
Operation of the terminal for this method is not very user-friendly: The user must initially call up the SMS menu in his terminal, which involves several key presses depending on the type of terminal, before even the request SMS can be created.

The object of the invention is thus to specify a method for authenticating a user on dialing into a WLAN network using a mobile terminal which overcomes the above-mentioned disadvantages of the SMS method. A further object of the invention is to specify a method for authentication which functions independently of the billing alternative selected by the user.

### ILLUSTRATION OF THE INVENTION

This object is achieved by a method in accordance with Patent claim 1. The requirement for the method in accordance with the invention is for a public hot spot to be available. Furthermore access to the mobile GSM, UMTS or similar mobile radio network must be possible. The GSM or UMTS user is in a position to be able to establish with his WLAN Client on the terminal a connection to the WLAN network. The user is billed on either a postpaid or a prepaid basis.

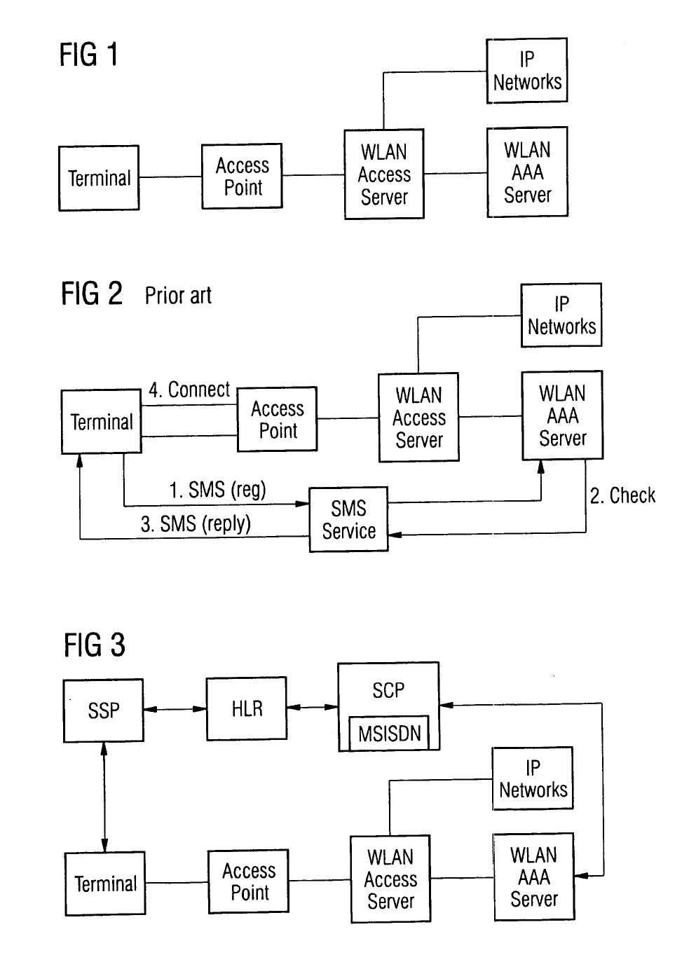

This requires a configuration as shown in FIG. 1. The user wishes to use WLAN access. To do this he must receive a WLAN authentication token. In this scenario the user needs a login and a password based on his MSISDN. However it is advantageous for the user for the login not to be the same as the MSISDN since this login is transported via the WLAN hot spot to the authentication server. The user thus expects a login password via a second, secure medium, in this case the mobile radio network.

Additional information, for example the time for which the user would like to use the WLAN, can be transmitted to the mobile network operator. This is of interest for accounting and charging.

The key point of the invention is that, for the transmission and communication of the authentication data with the WLAN, it is not the SMS protocol which is used but the alternative USSD (Unstructured Supplementary Serice Data) protocol. These so-called USSD strings can be easily entered by uers on their terminal keypads. The USSD string is then not sent to the SMS gateway, as in the known method, but is sent directly to the Home Location Register (HLF) of the mobile radio network. The Home Location register triggers the USSD string in accordance with CAMEL and then forwards it to the service logic in the SCP. Similar to the service logic in the SMSC (or coresponding service logic behind the SMSC) the service logic in the SCP, service server will evalute the USSD string.

Advantageous embodiments and developments of the invention are specified in the subclaims.

For the user it is advantageous for the USSD string, which will not essentially differ at the various times when it is used, to be stored in the telephone book. In this case the user can access the telephone book in his terminal at any time and this call to the WLAN is handled in exactly the same way as a regular telephone call.

### DESCRIPTION OF THE PREFERRED EMBODIMENT

The invention is described below on the basis of an exemplary embodiment. The Figures show

FIG. 1 a basic WLAN network architecture as is generally used,

FIG. 2 the authentication method in accordance with the prior art using SMS,

FIG. 3 the new authentication method using USSD, in accordance with the patent application.

The user wishes to use his WLAN access via a terminal, for example a mobile telephone, a laptop or similar (terminal). To do this, he must set up a connection to a WLAN hot spot (access point), which establishes access to the WLAN in which he is currently located. These hot spots are preferably located in heavily frequented areas, for example in the waiting areas of airports and train stations, as well as in hotels.

The hot spot is usually accessed via an air interface. The hot spot itself is then connected to the WLAN network using what is known as a WLAN access server. During login of a transaction the access authorization of the user is checked in the authentication server (WLAN AAA server). If the authorization is accepted the user can obtain access to the desired data network.

FIG. 2 describes a solution like the one generally employed, see also introduction to this Description. The user sends an SMS (SMS(REQ)) to a specialized SMS server. A specific SMS service number is available for this as a rule. This SMS is generally free-of-charge to the user. The SMS server itself checks the request, for example by requesting a user's access authorization from the WLAN-AAA server, and then takes the appropriate measures. The user is then sent the result of his inquiry in a further SMS (SMS (Replay)). With the content of the SMS which he has received from the SMS service the user can establish a connection to the WLAN (Connect). The disadvantages arising from this process have already been explained.

FIG. 3 now shows the method in accordance with the invention. The USSD Get Access-Code approach is used here. The method is based on the USSD protocol which allows the user to use simple key presses to send control signals to the network via a protocol. The advantage of the procedure is that this USSD string issued by the user is received at the Home Location Register (HLR) and further processed there. The user register triggers the USSD string in accordance with the CAMEL Standard and then forwards this to the service logic in the Service Control Point (SCP). The service logic in the SCP operates in a similar way to the service logic in an SMSC or an underlying network node.

The advantage of the method is that the user is no longer dependent on the store and forward principle of the SMS service.

The user enters the USSD string at his terminal:

A combination of standardized solutions is proposed for doing this. In this case the user enters a predefined character string which corresponds to a standardized structure which begins with a service access code, for example
“*111#”<SEND>. This character string can be used to make a payment using a known credit card of the user to the mobile radio network.
“*119*2#″<SEND>. This character string can be used to request a WLAN access for the next two hours.

These character strings can for example be stored in the telephone book of the terminal. Thus the user has access at any time and does not have the tedious task of manually entering the character string each time.

This USSD string is received in the user's Home Location Register (HLR), analyzed and forwarded to the GSM SCF (Service Control Function).

This GSM SCF in its turn has activated a service logic which receives the USSD string and generates a reply, the reply then contains the desired WLAN access information. This reply is then sent via the same path, namely the HLR, back to the user's terminal.

Authentication:

To obtain access to the WLAN, the user must now prove his identity to the access server of the WLAN (AAA server). The USSD sent by the terminal together with its MSISDN can be used for this purpose in the SCP service logic. The SCP ser vice logic requests an authorization token from the WLAN access server. The access server checks the MSISDN of the user and then authorizes this for access by sending an authorization token to the service logic. This authorization token is sent by the service logic to the user.

Last step: Login

The user can then log in using the authentication taken that he has received.

1. Method for authenticating a user for the purposes of establishing a connection from a mobile terminal.
(terminal) to a WLAN network by means of an authentication request which the access point (WLAN access server) receives from the terminal and which is checked by an authorization server (WLAN AAA server) for validity, characterized in that,
the request from the terminal is sent as a USSD message.

2. Method in accordance with Patent claim 1, characterized in that
the authentication request to the authorization server (WLAN AAA server)
is sent via a mobile radio network and
is routed from the Home Location Register (HLR) of a mobile radio network to a Service Control Point (SCP) and
the Service Control Point (SCP) generates a reply containing the WLAN authentication data.

3. Method in accordance with one of the previous patent claims,
characterized in that
the Service Control Point (SCP) processes the received authentication request together with a code (MSISDN) uniquely identifying the requesting user or the requesting mobile terminal and known to the mobile radio network.

4. Method in accordance with one of the previous patent claims,
characterized in that
the authentication request is stored as an entry in the telephone book of the mobile terminal.
